(19) United States
(12) Patent Application Publication
(10) Pub. No.: US 2025/0269632 A1
(43) Pub. Date: Aug. 28, 2025

(54) LOW STATIC DISCHARGE NON-BLOCKING MULTILAYER BARRIER FILM

(71) Applicant: TAGHLEEF INDUSTRIES INC., Newark, DE (US)

(72) Inventor: Eric PROPST, Terre Haute, IN (US)

(21) Appl. No.: 18/590,164

(22) Filed: Feb. 28, 2024

(51) Int. Cl. B32B 27/08; B32B 27/20; B32B 27/32; B32B 27/34; G09F 3/02; G09F 3/10

(52) U.S. Cl. CPC B32B 27/08; B32B 27/20; B32B 27/32; B32B 27/34; G09F 3/02; G09F 3/10; B32B 2250/24; B32B 2255/10; B32B 2255/26; B32B 2307/21; B32B 2307/518; B32B 2307/702; B32B 2307/704; B32B 2307/75; B32B 2519/00; G09F 2003/0258

(57) ABSTRACT

A multilayer film is disclosed, including a printable coating layer including a soft polyurethane, and defining a first surface of the multilayer film; a core layer under the printable coating layer; a barrier layer under the core layer and including a polyamide; and an adhesive receptive layer under the barrier layer, defining a second surface of the multilayer film opposite the first surface, and including a hard polyurethane, wherein: the soft polyurethane has a minimum film forming temperature (MFFT) <0° C.; the MFFT of the hard polyurethane is >0° C.; the hard polyurethane is effective to reduce static discharge from a roll of the multilayer film unwound at a rate of at least 600 m/min; and the multilayer film is biaxially oriented and exhibits a blocking force <1000 g. Also disclosed is a label including the multilayer film of the invention and ink bonded to the printable coating layer.

### BACKGROUND OF THE INVENTION

### 1. FIELD OF INVENTION

This invention relates to multilayer films for labels and packaging which function as barriers for oxygen and/or mineral oil.

### 2. DESCRIPTION OF RELATED ART

Printable barrier films are desirable and commercially available for labels and packaging films. See, e.g., US20200061968 A1. Printability is achieved with film treatment and selection of specific polymers. Soft polyurethane (minimum film forming temperature <0° C.) coatings are particularly favored for print adhesion and compatibility with many forms of printing inks such as flexographic and UV cure. There are numerous polymer layers that can be selected to achieve a barrier property against oxygen or mineral oil, such as a metal oxide, metal, EVOH or polyamide. For example, U.S. Pat. No. 10,926,518 B2 discloses a biaxially oriented polypropylene (BOPP) multilayer film having an outer skin layer comprising a polyamide. The outer skin layer can be coated with at least one of a metal, metal oxide, organic and inorganic lacquers.

Polyamide is in many cases a preferred material owing to its inherent chemical and physical durability as well as its naturally high surface energy that promotes adhesion.

A film that contains a blend of hard and soft polyurethanes on one external print surface, and polyamide (or amide blend) on the opposing surface is a desirable commercial construction for packaging and labels. This construction is commercially available, but suffers from a triboelectric mismatch between the urethane print surface and the polyamide barrier surface. This extreme difference in position on the triboelectric scale results in severe and dangerous electrical discharge when a roll of material is unwound a high speed (at least 600 m/min). The static issue cannot be resolved using static bar, tinsel, or ionized air. The tendency for the two surfaces to exchange electrons and create a high voltage field occurs immediately upon separation of the layers of film upon the act of unrolling. There is no time for traditional static dissipation techniques to work.

Antistatic coatings such as ST8902WB EU produced by Toasf (Afula, Israel) and polyoxyethylene (20) sorbitan monolaurate, commonly referred to as polysorbate 20, can reduce the intensity of the static discharge. However, attempts to use these materials results in either film blocking, or undesirable inconsistent transfer to the opposing polyurethane print surface.

It is therefore desired to provide printable barrier films comprising polyamides, which do not produce significant static discharge when unwound from rolls at high speed, and which do not suffer from blocking.

All references cited herein are incorporated herein by reference in their entireties.

### BRIEF SUMMARY OF THE INVENTION

Accordingly, a first aspect of the invention is a multilayer film comprising: a printable coating layer comprising a soft polyurethane, and defining a first surface of the multilayer film; a core layer under the printable coating layer; a barrier layer under the core layer and comprising a polyamide; and an adhesive receptive layer under the barrier layer, defining a second surface of the multilayer film opposite the first surface, and comprising a hard polyurethane, wherein: the soft polyurethane has a minimum film forming temperature (MFFT) less than 0° C.; the MFFT of the hard polyurethane is greater than 0° C.; the hard polyurethane is effective to reduce static discharge from a roll of the multilayer film unwound at a rate of at least 600 m/min; the multilayer film is biaxially oriented; and the multilayer film exhibits a blocking force of less than 1000 g.

In certain embodiments, the core layer comprises polypropylene.

In certain embodiments, the core layer comprises 32-96 wt. % of polypropylene, and at least one member selected from the group consisting of: 1.5-30 wt. % of titanium dioxide; 1.5-23 wt. % CaCO₃; and 1-15 wt. % polybutylene terephthalate.

In certain embodiments, the multilayer film further comprises a printable coating receptive layer between the printable coating layer and the core, said printable coating receptive layer comprising olefin copolymers comprising polar comonomers.

In certain embodiments, the printable coating receptive layer comprises at least one member selected from the group consisting of vinyl acetate, alkyl acrylate, alkyl methacrylate, acrylic acid, maleic anhydride, propylene homopolymer, propylene copolymer, propylene terpolymer, and copolymer of alpha-olefins comprising ethylene or propylene co-monomers, propylene or ethylene elastomers.

In certain embodiments, the multilayer film further comprises a tie layer between the printable coating receptive layer and the core layer, wherein the tie layer comprises: (a) at least one polymer selected from the group consisting of propylene homopolymer, propylene copolymer with ethylene, propylene copolymer with 1-butene, and propylene terpolymer with ethylene and 1-butene; (b) the at least one polymer of (a) grafted with at least one polar comonomer selected from the group consisting of vinyl acetate, methyl (meth) acrylate, butyl (meth) acrylate, acrylic acid and maleic anhydride; or (c) blends of the at least one polymer of (a) with copolymers of ethylene with at least one polar comonomer selected from the group consisting of vinyl acetate, methyl (meth) acrylate, butyl (meth) acrylate, acrylic acid and maleic anhydride.

In certain embodiments, the multilayer film further comprises an additional tie layer between the core layer and the barrier layer, wherein the additional tie layer comprises: (a) at least one polymer selected from the group consisting of propylene homopolymer, propylene copolymer with ethylene, propylene copolymer with 1-butene, and propylene terpolymer with ethylene and 1-butene; (b) the at least one polymer of (a) grafted with at least one polar comonomer selected from the group consisting of vinyl acetate, methyl (meth) acrylate, butyl (meth) acrylate, acrylic acid and maleic anhydride; or (c) blends of the at least one polymer of (a) with copolymers of ethylene with at least one polar comonomer selected from the group consisting of vinyl acetate, methyl (meth) acrylate, butyl (meth) acrylate, acrylic acid and maleic anhydride.

In certain embodiments, the multilayer film further comprises a tie layer between the core layer and the barrier layer, wherein the tie layer comprises: (a) at least one polymer selected from the group consisting of propylene homopolymer, propylene copolymer with ethylene, propylene copolymer with 1-butene, and propylene terpolymer with ethylene and 1-butene; (b) the at least one polymer of (a) grafted with at least one polar comonomer selected from the group consisting of vinyl acetate, methyl (meth) acrylate, butyl (meth) acrylate, acrylic acid and maleic anhydride; or (c) blends of the at least one polymer of (a) with copolymers of ethylene with at least one polar comonomer selected from the group consisting of vinyl acetate, methyl (meth) acrylate, butyl (meth) acrylate, acrylic acid and maleic anhydride.

In certain embodiments, the barrier layer comprises at least one amorphous or semi-crystalline polyamide having a viscosity of 100-3000 cm³/g.

In certain embodiments, the adhesive receptive layer further comprises at least one of a wax, antiblock particles, a defoamer, a wetting agent, and a colorant.

In certain embodiments, the MFFT of the hard polyurethane is greater than 20° C.

In certain embodiments, the blocking force is less than 400 g.

In certain embodiments, the roll of the multilayer film which is 90 cm in diameter and 200 cm wide exhibits a static charge of less than 20000 volts while being unwound at 600 m/min.

In certain embodiments, the static charge is less than 5000 volts.

A second aspect of the invention is a label comprising the multilayer film of the invention and ink bonded to the printable coating layer.

### DETAILED DESCRIPTION OF PREFERRED EMBODIMENTS OF THE INVENTION

### Glossary

Throughout the description, where the invention is specified as “having”, “including” or “comprising” (or other conjugations thereof) a feature, it should be understood that these are open terms such that the invention may include additional features. In addition, where an embodiment of the invention is specified as having, including or comprising a feature, the invention also encompasses alternative embodiments wherein additional features are strictly excluded (as indicated by the use of the transitional phase “consisting of”) and alternative embodiments wherein additional features are excluded only if they will have a material effect on the invention (as indicated by the use of the transitional phrase “consisting essentially of”).

Where an element or component is said to be included in and/or selected from a list of recited elements or components, it should be understood that the element or component can be any one of the recited elements or components and can alternatively be selected from the group consisting of any combination of two or more of the recited elements or components.

The use of the singular herein includes the plural (and vice versa) unless specifically stated otherwise. Thus, the terms “a” and “an” mean “at least one” unless stated otherwise.

The term “substantially free of” refers to an inconsequential amount of a stated ingredient or thing. “Free of” refers to no detectable amount of the stated ingredient or thing.

The dimensions and values disclosed herein are not to be understood as being strictly limited to the exact numerical values recited. Instead, unless otherwise specified, each such dimension is intended to mean both the recited value and functionally equivalent range surrounding that value. For example, a volume of “40 ml” is intended to mean “about 40 ml”. Where the term “about” is used before a quantitative value, the present teachings also include the specific quantitative value itself, unless specifically stated otherwise.

It should be understood that the order of steps or order for performing certain actions is immaterial so long as the present teachings remain operable. Moreover, two or more steps or actions can be conducted simultaneously.

Unless specified otherwise the following terms shall have the specified meanings set forth below:

“Ambient” refers to surrounding conditions at about one atmosphere of pressure, about 50% relative humidity and about 25° C. Ambient conditions should be understood to apply unless otherwise specified.

“Olefin polymer” and “polyolefin” mean a homopolymer, copolymer or terpolymer in which all of the monomer units in such polymers are olefins.

“Propylene polymer” means a propylene homopolymer, or a copolymer or a terpolymer in which the predominant monomer component by weight is propylene.

“Propylene terpolymer” or “polypropylene terpolymer” means a propylene, ethylene, butene terpolymer in which propylene is the predominant monomer unit by weight.

“Propylene ethylene copolymer” or “polypropylene ethylene copolymer” and “propylene butene-1 copolymer” or “polypropylene butene-1 copolymer” means propylene ethylene or propylene butene-1 copolymer in which propylene is the predominant monomer unit by weight.

“Polypropylene homopolymer”⁻ includes, in addition to a homopolymer, a polypropylene ethylene copolymer in which the percentage of ethylene is so little that it does not adversely affect the crystallinity or other properties of the propylene homopolymer. These copolymers are referred to as “mini random” copolymers and have a percentage of ethylene, by weight of the copolymer, of 1% or less.

“Butene copolymer” as used herein refers to a copolymer in which butene-1 is the predominant monomer with ethylene or propylene.

“Polyolefin elastomer” as used herein refers to hard segments of crystalline polypropylene with amorphous ethylene propylene copolymer segments, such as Vistamaxx (Exxon Mobile)

“Density” of the film or label formed therefrom is determined by the displacement procedure of ASTM D792 test method.

“Opacity” of a film or label formed therefrom is determined in accordance with TAPPI T425 test method.

“MD” and “TD” refer to the machine direction and the transverse direction in the manufacturing process, respectively.

“Measured Thickness” is determined by cross-section microtoming a thin slice of the film and viewing the cross-section under a scanning electron microscope with a calibrated image scale to determine individual layer thicknesses of the multilayer film.

The terms “biaxial” and “bidirectional” are synonymous terms for specifying the direction of orientation of films in which the draw ratio in both the MD and TD directions is greater than 2.0×.

All percentages and ratios are calculated by weight unless otherwise indicated and are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Multilayer Film

The inventive film is preferably a biaxially oriented film comprising a printable coating layer (PCL) comprising polyurethane on one surface and an adhesive receptive layer (ARL) comprising hard polyurethane on the opposing surface of the film, which resists blocking and dramatically reduces static discharge when a roll of the film is unwound at high speed (as compared to a film where the hard urethane adhesive receptive layer is not present). In preferred embodiments, the static discharge of the inventive film is not a safety hazard and ideally is minimally present (less than 2000 V) when a roll 90 cm in diameter and 200 cm wide stored for three weeks at room temperature is unwound at 600 m/min. In addition, said film does not show evidence of blocking. It is surprising that the addition of a hard polyurethane surface in opposition to a soft polyurethane surface does not result in blocking between the two types of polyurethane surfaces when a commercial scale roll (200 cm wide, and 80 cm in diameter) is formed and stored for at least three weeks as would typically be the case in commercial use.

The multilayer film further comprises the following layers in order from the PCL to the ARL: a printable coating receptive layer (PCRL), a core layer and a barrier layer. The multilayer film optionally has a tie layer between the core layer and the PCRL and/or optionally has a tie layer between the core layer and the barrier layer. The multilayer film is preferably a structure of three or more layers, such as, e.g., a laminate of 5, 6 or 7 layers. Specific examples of suitable arrangements of layers in a multilayer film of the invention include but are not limited to the following four embodiments:

| 1 | 2 | 3 | 4 |
|---|---|---|---|
| PCL | PCL | PCL | PCL |
| PCRL | PCRL | PCRL | PCRL |
| Core | Tie | Core | Tie |
| Barrier | Core | Tie | Core |
| ARL | Barrier | Barrier | Tie |
| | ARL | ARL | Barrier |
| | | | ARL |

### Printable Coating Layer

This PCL comprises a soft polyurethane that is particularly useful for forming a strong bond with inks associated with flexographic, lithographic, UV curable and/or thermal transfer ink. The term “soft” is commonly used in the industry and directly related to the low durometer of the material. This durometer of a thin coating is difficult to measure because the base physical properties of the base film upon which it has been coated strongly influences the measurement of durometer. Therefore, soft polyurethanes are commonly identified based on their minimum film forming temperature (MFFT). This characteristic is measured with an MFFT device sold by Rhopoint Instruments (Troy, MI) to perform the method of ASTM D2354. Soft polyurethanes as defined herein have an MFFT as measured by said method of less than 0° C. and hard urethanes as defined herein have an MFFT of greater than 0° C.

The printable coating layer preferably has a thickness of 0.05 to 0.5 microns.

### Printable Coating Receptive Layer

The PCRL is preferably coextruded and is preferably formed from olefin copolymers comprising polar comonomers such as vinyl acetate, alkyl acrylates, alkyl methacrylates, acrylic acid or maleic anhydride. In certain embodiments, this layer may include, e.g., propylene homopolymer, copolymer or terpolymer, copolymers of alpha-olefins comprising ethylene or propylene co-monomers, propylene or ethylene elastomers, or mixtures thereof.

The PCRL preferably has a thickness of 0.2 to 2 microns, more preferably 0.5 to 1 microns.

### Core Layer

The core layer preferably comprises polypropylene (PP), and preferably has a thickness of 10 to 100 microns. The core can further comprise at least one the following additional ingredients: 1.5-30 wt. % of titanium dioxide, 1.5-23 wt. % CaCO₃, 1-15 wt. % polybutylene terephthalate (PBT), ethylene acrylic acid copolymer (EAA), GMS and/or amides of fatty acids.

### Barrier Layer

The barrier layer preferably comprises at least one amorphous or semi-crystalline polyamide. Suitable amorphous polyamides can be selected, by way of non-restrictive example, from the group consisting of polyamide 4I (consisting essentially of tetramethylenediamine and isophthalic acid), polyamide 4I/4T (tetramethylenediamine copolymers with a mixture of isophthalic acid and acid terephthalic acid), polyamide 6I (consisting essentially of hexamethylene diamine and isophthalic acid), polyamide 6I/6T (hexamethylenediamine copolymers with a mixture of isophthalic acid and terephthalic acid), polyamide 6I/69/66 (hexamethylene diamine copolymers with a mixture of isophthalic acid, azelaic acid and adipic acid), polyamide DT/DI (copolymers of 2-methyl pentamethylene diamine with a mixture of isophthalic acid and terephthalic acid), and polyamide 6/3-T (resins based on terephthalic acid and 2,2,4-trimethylhexamethylenediamine).

These amorphous and semi-crystalline polyamides preferably have a viscosity in the range of 100-3000 cm³/g, more preferably 180-400 cm³/g, even more preferably 200-260 cm³/g.

Suitable semicrystalline polyamides can be selected, by way of non-restrictive example, from the group of copolymers consisting of polyamide 6, polyamide 6/6T, polyamide 6.6, polyamide 6/6.6, polyamide 4.6, polyamide 4.10, polyamide 4.12, polyamide 6.10, polyamide 6.12, polyamide MDX6, and polyamide 6/3-T.

The amorphous polyamides can be selected from polyamide 6/3-T, polyamide 4I/4T and polyamide 6I/6T, polyamide 6I/69/66, polyamide 6/6.6, polyamide DT/DI, semi-crystalline polyamides can be selected from polyamide 6, polyamide 6-3T, polyamide 6/6T copolymer, polyamide 6/6.6, polyamide 6.10, and polyamide MDX6. Commercial examples of amorphous polyamides are Grilon FE4494, Grilon FE4495, Grivory G21 (EMS), Selar PA 3626 (Du Pont), Trogamid T5000 (Evonik), Novadyn DT/DI, examples of semicrystalline polyamides are Ultramid C33L01 (BASF), K7007C (Mitsubishi Gas Chemical Co), Grilon F34 (EMS), and Trogamid MX97.

The barrier layer preferably has a thickness of 0.2 to 5 microns, more preferably 0.5 to 2 microns and most preferably 0.5 to 1 microns.

### Tie Layer

Each tie layer independently comprises propylene homopolymer or propylene copolymer or terpolymer with ethylene and/or 1-butene, grafted with polar comonomers such as vinyl acetate, methyl (meth) acrylate, butyl (meth) acrylate, acrylic acid or maleic anhydride and blends of homopolymer, copolymers or terpolymers of propylene with copolymers of ethylene with polar comonomers such as vinyl acetate, methyl (meth) acrylate, butyl (meth) acrylate, acrylic acid or maleic anhydride. Grafted copolymers can be selected from the group consisting of PolyBond 3150 (Chemtura), Admer QF500A, Admer AT1 179E (Mitsui Chemicals Europe), G-3003 (Eastman), Fusabond MD51 1D (DuPont), SCONA TPPP9212 FA/GA (Byk Chemie) and similar resins.

### Adhesive Receptive Layer

The ARL comprises a hard urethane having a minimum film forming temperature greater than 0° C. In certain embodiments, the MFFT is 1-100° C. or 10-90° C. or 20-80° C. Preferably, the MFFT is greater than 20° C. If the hardness of the ARL does not exceed the hardness of the PCL, blocking will result. The ARL can comprise in addition to the polyurethane at least one of: wax, antiblock particles, defoamer, wetting agents, and/or colorants. Ideally, the ARL is an aqueous dispersion.

The ARL can be applied in any standard coating method such as, gravure, reverse gravure, Myer rod, kiss, slot die, etc. The ARL is then dried sufficiently to remove the water or solvent from the coating mixture. Drying methods can include hot air, near IR, or microwave. Both the printable coating layer and the adhesive receptive layer can be coated at the same time, in series, or in two separate coating process steps.

Useful hard aliphatic polyurethanes include but are not limited to NeoRez R620, R32202 or R972 sold by Covestro (Lueverkusen Germany). NeoPac E-125 by Covestro is also suitable. Further non-limiting examples of suitable polyurethanes include Joncryl U4190, U4501, HYB6336, or HYB6340 by BASF (Ludwigshafen Germany).

The ARL preferably has a thickness of 0.01 to 1 microns.

The invention will be illustrated in more detail with reference to the following Examples, but it should be understood that the present invention is not deemed to be limited thereto.

### EXAMPLES

### Blocking Test

Prepare the films to be blocked by cutting six 6.35 cm×8.9 cm pieces of film. Lay the film surfaces together on which the blocking force will be measured. Place the samples on a raised metal surface 2.54 cm×5.1 cm where the applied force can be directed to the sample. Apply 1034 kPa to the sample. While maintaining pressure on the sample, place the sample in an oven at 55° C. for 3 hours. Remove the samples from the oven, remove the pressure, and allow the samples to cool for 1 hour.

For blocking force testing using an Instron, straddle the two film ends around an immovable rod with a diameter of 7.13 mm. Place both free ends in the movable load cell clamps. Measure the peak force (g/cm) as the cross head moves at 50.8 cm/min causing the two films to be pulled apart. The peak force for separating the films is the blocking force.

### Minimum Film Forming Temperature

ASTM D2354 was performed using a device sold by Rhopoint Instruments of Troy Michigan.

### Static Observation

Because the problem of static generation is associated with the rapid separation of layers of film during commercial unwinding of large rolls of film, lab tests are not useful. Common testing of static decay is not relevant because the phenomena is related to charge generation. Consequently, the only way to assess whether a solution is useful is to observe large rolls being unwound at speeds of approximately 600 m/min. The assessment is a judgment regarding the industrial safety of the discharge. The discharge does not need to achieve zero, this is not attainable for plastic film processing today. In certain embodiments, the electrostatic charge is less than 30,000 volts, or less than 20,000 volts or less than 10,000 volts or less than 5,000 volts or less than 2,000 volts or less than 1,000 volts.

The two examples which follow demonstrate the effectiveness of this invention using a commercial film, namely PPGP 65 available from Taghleef Industries (Newark, DE). The film consists of a printable surface that contains a soft polyurethane coating on one external surface. The opposing external surface is a coextruded polyamide that offers excellent oxygen and mineral oil barrier, chemical resistance, and durability.

### Example 1

In this example, a hard polyurethane solution containing 10% R620 (Covestro; Leverkusen, Germany), 89.95% water, and 0.05% BYK024 (BYK Chemie; Wesel, Germany) was coated on the polyamide external surface of the commercial film, using a gravure roll and dried at 115° C. The roll was wound to commercial size (90 cm in diameter and 200 cm wide). To evaluate the film for blocking, the roll was stored for three weeks in a warehouse. After the three weeks, the roll was unwound at 600 m/min and observed for the presence of extensive static discharge as the roll unwound (which is present if the polyamide layer comes in direct contact with the printable soft polyurethane). The sample was also evaluated for blocking using a laboratory scale test that has been correlated to the tendency of film to block at commercial scale. The force to pull the two surfaces apart should be less than 1000 g. The results are summarized in Table 1 below.

### Example 2 (Comparative)

This comparative example showed that the hard nature of the urethane is important. The use of soft urethane (minimum film forming temperature <0° C.) in this comparative example resulted in severe blocking. In this comparative example, a mixture of 10% R600 (Covestro; Leverkusen, Germany), 89.95% water, and 0.05% BYK024 was coated and dried on the commercial film in a manner similar to Example 1. The film was tested for blocking in the lab scale test. A roll was stored for three weeks in a warehouse. After three weeks, the roll was prepared to be unwound to observe static discharge. However, the roll completely blocked and could not be unwound and prevented the observation from taking place. The lab test predicted this outcome.

TABLE 1

| | | Urethane Minimum | | | Static Discharge |
|---|---|---|---|---|---|
| | Adhesive | Film Forming | Lab Scale | | Behavior |
| | Receptive | Temperature | Blocking | Commercial Scale | During Roll |
| Example | Surface | (° C.) | Force (g) | Blocking Results | Unwind |
| 1 | Hard | 33 | 320 | None | Acceptable |
| | Polyurethane | | | | |
| 2 | Soft | <0 | 1650 | Unacceptable | Unknown because |
| | Polyurethane | | | | of blocking |

While the invention has been described in detail and with reference to specific examples thereof, it will be apparent to one skilled in the art that various changes and modifications can be made therein without departing from the spirit and scope thereof.

What is claimed is:

1. A multilayer film comprising:
a printable coating layer comprising a soft polyurethane, and defining a first surface of the multilayer film;
a core layer under the printable coating layer;
a barrier layer under the core layer and comprising a polyamide; and
an adhesive receptive layer under the barrier layer, defining a second surface of the multilayer film opposite the first surface, and comprising a hard polyurethane,
wherein:
the soft polyurethane has a minimum film forming temperature (MFFT) less than 0° C.;
the MFFT of the hard polyurethane is greater than 0° C.;
the hard polyurethane is effective to reduce static discharge from a roll of the multilayer film unwound at a rate of at least 600 m/min;
the multilayer film is biaxially oriented; and
the multilayer film exhibits a blocking force of less than 1000 g.

2. The multilayer film of claim 1, wherein the core layer comprises polypropylene.

3. The multilayer film of claim 1, wherein the core layer comprises 32-96 wt. % of polypropylene, and at least one member selected from the group consisting of:
1.5-30 wt. % of titanium dioxide;
1.5-23 wt. % CaCO₃; and
1-15 wt. % polybutylene terephthalate.

4. The multilayer film of claim 1, further comprising a printable coating receptive layer between the printable coating layer and the core, said printable coating receptive layer comprising olefin copolymers comprising polar comonomers.

5. The multilayer film of claim 4, wherein the printable coating receptive layer comprises at least one member selected from the group consisting of vinyl acetate, alkyl acrylate, alkyl methacrylate, acrylic acid, maleic anhydride, propylene homopolymer, propylene copolymer, propylene terpolymer, and copolymer of alpha-olefins comprising ethylene or propylene co-monomers, propylene or ethylene elastomers.

6. The multilayer film of claim 4, further comprising a tie layer between the printable coating receptive layer and the core layer, wherein the tie layer comprises: (a) at least one polymer selected from the group consisting of propylene homopolymer, propylene copolymer with ethylene, propylene copolymer with 1-butene, and propylene terpolymer with ethylene and 1-butene; (b) the at least one polymer of (a) grafted with at least one polar comonomer selected from the group consisting of vinyl acetate, methyl (meth) acrylate, butyl (meth) acrylate, acrylic acid and maleic anhydride; or (c) blends of the at least one polymer of (a) with copolymers of ethylene with at least one polar comonomer selected from the group consisting of vinyl acetate, methyl (meth) acrylate, butyl (meth) acrylate, acrylic acid and maleic anhydride.

7. The multilayer film of claim 6, further comprising an additional tie layer between the core layer and the barrier layer, wherein the additional tie layer comprises: (a) at least one polymer selected from the group consisting of propylene homopolymer, propylene copolymer with ethylene, propylene copolymer with 1-butene, and propylene terpolymer with ethylene and 1-butene; (b) the at least one polymer of (a) grafted with at least one polar comonomer selected from the group consisting of vinyl acetate, methyl (meth) acrylate, butyl (meth) acrylate, acrylic acid and maleic anhydride; or (c) blends of the at least one polymer of (a) with copolymers of ethylene with at least one polar comonomer selected from the group consisting of vinyl acetate, methyl (meth) acrylate, butyl (meth) acrylate, acrylic acid and maleic anhydride.

8. The multilayer film of claim 4, further comprising a tie layer between the core layer and the barrier layer, wherein the tie layer comprises: (a) at least one polymer selected from the group consisting of propylene homopolymer, propylene copolymer with ethylene, propylene copolymer with 1-butene, and propylene terpolymer with ethylene and 1-butene; (b) the at least one polymer of (a) grafted with at least one polar comonomer selected from the group consisting of vinyl acetate, methyl (meth) acrylate, butyl (meth) acrylate, acrylic acid and maleic anhydride; or (c) blends of the at least one polymer of (a) with copolymers of ethylene with at least one polar comonomer selected from the group consisting of vinyl acetate, methyl (meth) acrylate, butyl (meth) acrylate, acrylic acid and maleic anhydride.

9. The multilayer film of claim 1, wherein the barrier layer comprises at least one amorphous or semi-crystalline polyamide having a viscosity of 100-3000 cm³/g.

10. The multilayer film of claim 1, wherein the adhesive receptive layer further comprises at least one of a wax, antiblock particles, a defoamer, a wetting agent, and a colorant.

11. The multilayer film of claim 1, wherein the MFFT of the hard polyurethane is greater than 20° C.

12. The multilayer film of claim 1, wherein the blocking force is less than 400 g.

13. The multilayer film of claim 1, wherein a roll of the multilayer film which is 90 cm in diameter and 200 cm wide exhibits a static charge of less than 20000 volts while being unwound at 600 m/min.

14. The multilayer film of claim 13, wherein the static charge is less than 5000 volts.

15. A label comprising the multilayer film of claim 1 and ink bonded to the printable coating layer.
